(19) United States
(12) Patent Application Publication
(10) Pub. No.: US 2011/0137523 A1
(43) Pub. Date: Jun. 9, 2011

(54) Motor Driven Power Steering Device

(75) Inventors: Seok Joo LEE, Yongin-si (KR); Hyun Sung, Hwaseong-si (KR); Un Koo Lee, Seoul (KR); Se Il Kim, Suwon-si (KR)

(73) Assignee: HYUNDAI MOTOR COMPANY, Seoul (KR)

(21) Appl. No.: 12/876,503

(22) Filed: Sep. 7, 2010

(30) Foreign Application Priority Data
Dec. 3, 2009 (KR) 10-2009-0119363

(51) Int. Cl. B62D 6/00

(52) U.S. Cl. 701/41

(57) ABSTRACT

A motor driven power steering device may include a motor drive unit equipped with a motor moving a rack so as to change steering angle, and a control unit detecting a moving direction of a steering wheel, operating the motor in accordance with the moving direction, and controlling the motor so as to vary the maximum stroke of the rack. The rack stroke may be increased in a predetermined control range of a wheel stroke and the rack stroke may be decreased out of a predetermined control range of a wheel stroke in such a manner that the gap between the wheel and the vehicle body is actively controlled. Further, a separate varying device for limiting the movement of the rack is not included such that the number of components and the manufacturing cost is reduced.

### CROSS-REFERENCE TO RELATED APPLICATION

This application claims priority to and the benefit of Korean Patent Application No. 10-2009-0119363 filed in the Korean Intellectual Property Office on Dec. 3, 2009, the entire contents of which application is incorporated herein for all purposes by this reference.

### BACKGROUND OF THE INVENTION

1. Field of the Invention

The present invention relates to a motor driven power steering device. More particularly, the present invention relates to a motor driven power steering device that varies the stroke of a rack depending on a driving condition.

2. Description of Related Art

Generally, a power steering device for steering a vehicle includes a hydraulic pressure type and a motor driven type, and recently the motor driven type has been gradually substituted for the hydraulic pressure type and the application range is becoming wider from compact to large vehicles.

However, in a case that the variable rack stroke device is mounted in a motor driven power steering device, an operating apparatus for limiting the rack stroke of the steering device may have to be further mounted, such that the number of related components and the assembly cost thereof increase.

Further, in a case when the variable rack stroke device is off, there is a problem that the gap between the wheel and the vehicle body excessively decreases while the vehicle is in a full bump condition (vehicle body becomes closer to the ground) or the vehicle is in a full rebound condition (vehicle becomes farther from the ground)

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a motor driven power steering device having advantages of reducing assembly cost and the number of components, and varying a rack stroke.

A motor driven power steering device according to various embodiments of the present invention may include a motor drive unit equipped with a motor moving a rack so as to change steering angle, and a control unit detecting a moving direction of a steering wheel, operating the motor in accordance with the moving direction, and controlling the motor so as to vary the maximum stroke of the rack.

The control unit may reduce the maximum stroke of the rack by a predetermined amount in a case that an operating switch is on.

The control unit may vary the maximum stroke of the rack to a predetermined value in a case that an operating switch is off.

A vehicle height sensor unit may include a vehicle height sensor fixed on a vehicle body, and a link of which a lower end is fixed to a lower arm, and an upper end is connected to the vehicle height sensor, wherein the vehicle height sensor detects movement of the link connected to the lower arm and calculates distance between the vehicle body and the lower arm, and the control unit calculates the wheel stroke amount based on the distance between the vehicle body and the lower arm.

The maximum stroke of the rack may be increased in a case that the wheel stroke is in a predetermined control range.

The maximum stroke of the rack may be decreased in a case that the wheel stroke is out of a predetermined control range.

In a motor driven power steering device according to the present invention as stated above, the motor of the motor drive unit of a steering device is controlled, the rack stroke is increased in a predetermined control range of a wheel stroke, and the rack stroke is decreased out of a predetermined control range of a wheel stroke, in such a manner that the gap between the wheel and the vehicle body is actively controlled.

Further, a separate varying device for limiting the movement of the rack is not included such that the number of components and the manufacturing cost are reduced.

### BRIEF DESCRIPTION OF THE DRAWINGS

FIG. 1 is a schematic diagram of an exemplary motor driven power steering device according to the present invention.

FIG. 2 is a perspective view of an exemplary motor driven power steering device according to the present invention.

FIG. 3 is a control flowchart of an exemplary motor driven power steering device according to the present invention.

FIG. 4 is a table showing operating conditions of an exemplary motor driven power steering device according to the present invention.

FIG. 5 is a graph showing relations between a vehicle height and a rack stroke in an exemplary motor driven power steering device according to the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

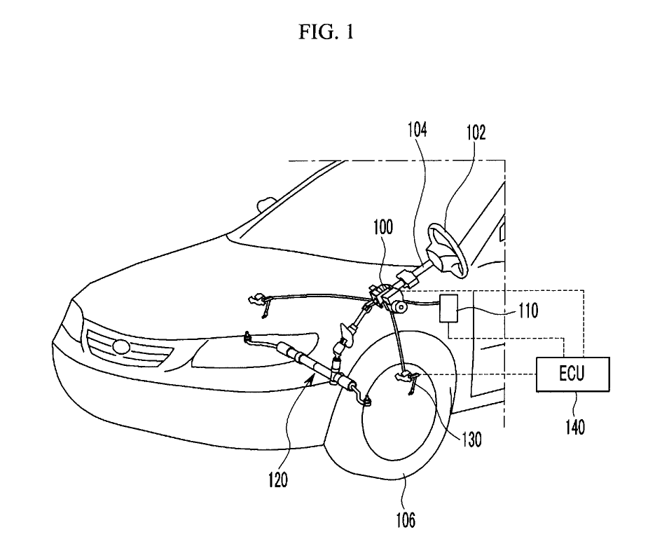

Referring to FIG. 1, motor driven power steering device includes a steering wheel 102, a steering column 104, a motor drive unit 100, a rack 120, a wheel 106, a vehicle height sensor unit 130, an operating switch 110, and a control unit 140.

A driver rotates the steering wheel 102 so as to adjust the moving direction of a vehicle, the torque thereof is transferred to the rack 120 through the steering column 104, and the steering angle of the wheel 106 is varied depending on the left/right movement of the rack 120.

The motor drive unit 100 is mounted at the steering column 104 and moves the rack 120 according to the movement of the steering wheel 102. The vehicle height sensor unit 130 detects the height variation of the vehicle and transfers the signal thereof to the control unit 140.

If the operating switch 110 is on, the maximum value of the rack stroke of the rack 120 is decreased by a predetermined amount. Further, if the operating switch 110 is turned off, the maximum stroke of the rack 120 is variably increased according to a bump or a rebound condition of the vehicle body 220.

In various embodiments of the present invention, the control unit 140 detects bump or rebound condition of the vehicle body 220 by a signal that is transferred from the vehicle height sensor unit 130 and controls the operation of the motor drive unit 100.

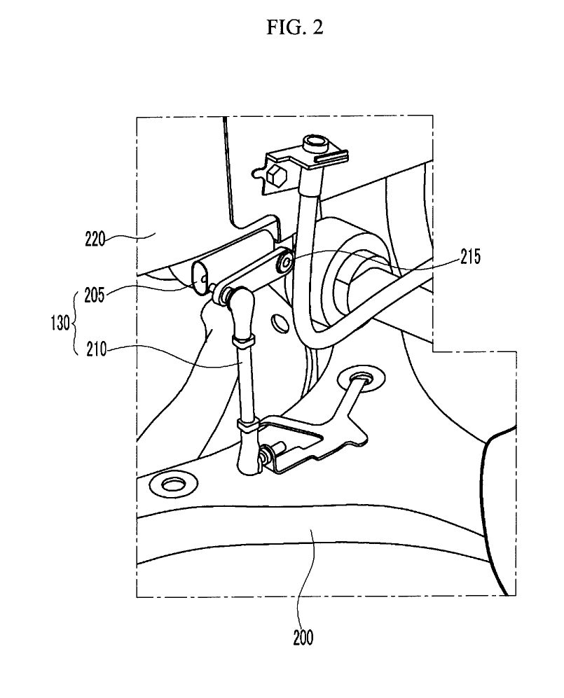

Referring to FIG. 2, the vehicle height sensor unit 130 includes a sensor 205 and a link 210. A lower end portion of the link 210 is connected to a lower arm 200, and an upper end portion of the link 210 is connected to the sensor 205 through a hinge 215.

The link 210 rotates the hinge 215 that is mounted on the sensor 205 according to the lower arm 200, and the sensor 205 detects rotation amount of the hinge 215 and detects the distance between the lower arm 200 and the vehicle body 220 from the rotation amount.

The control unit 140 calculates the stroke of the wheel 106 based on the distance between the lower arm 200 and the vehicle body 220.

In various embodiments of the present invention, the distance between the lower arm 200 and the vehicle body 220 is varied depending on the weight of a load or passengers. Further, the lower arm 200 moves downwards or upwards in accordance with the road condition.

Here, a condition in which the distance between the lower arm 200 and the vehicle body 220 becomes closer is called “bump”, and a condition in which the distance between the lower arm 200 and the vehicle body 220 becomes longer is called “rebound”.

In various embodiments of the present invention, the maximum that the rack 120 can move to steer the wheel 106 is varied in the full bump or the full rebound condition that the distance between the lower arm 200 and the vehicle body 220 becomes closer or longer.

The maximum rack stroke that the rack 120 moves is determined by the gap between the wheel 106 and the components of the vehicle body, and the maximum of the rack stroke can be set at a design or assembly step.

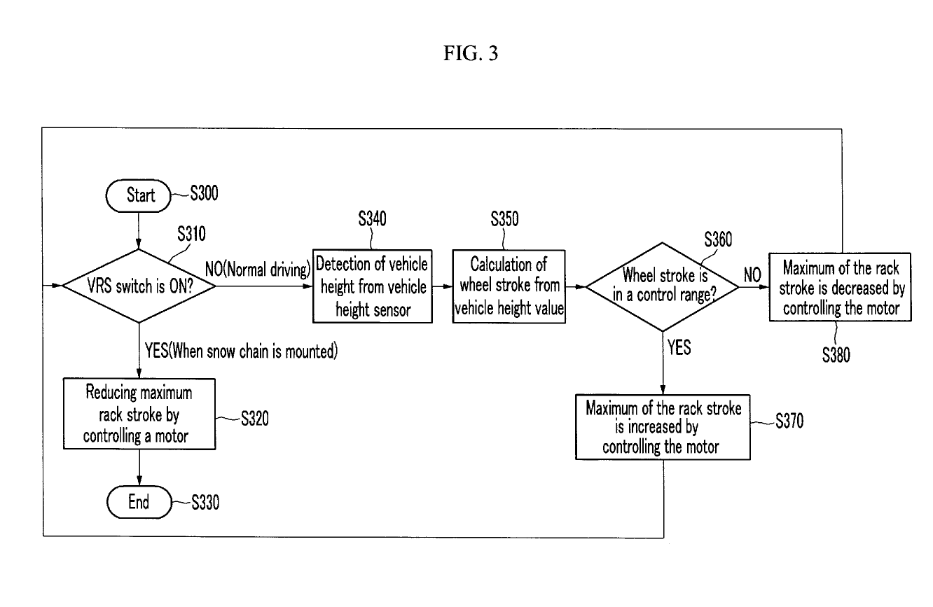

Referring to FIG. 3, the control method includes a zero step S300, a first step S310, a second step S320, a third step S330, a fourth step S340, a fifth step S350, a sixth step S360, a seventh step S370, and an eighth step S380.

In the zero step S300, control is initiated, and in the first step S310, it is determined if the operating switch 110 is on or off.

If the operating switch 110 is on, the motor drive unit 100 operates a motor in the second step S320 so as to reduce the maximum stroke of the rack 120. When a chain is wrapped on the wheel 106 so as to prevent slip thereof on a snowy road, the operating switch is turned on.

In the fourth step S340, the distance signal between the vehicle body 220 and the lower arm 200 is measured from the vehicle height sensor unit 130. In the fifth step S350, the moving stroke of the wheel 106 is calculated by the signal transferred from the vehicle height sensor unit 130.

If the stroke of the wheel 106 is within a predetermined control range in the sixth step S360, the maximum stroke of the rack 120 is increased by a predetermined amount by controlling the motor of the motor drive unit 100 in the seventh step S370.

If it is determined that the stroke of the wheel 106 is out of the predetermined control range in the sixth step S360, the maximum stroke of the rack 120 is decreased by a predetermined amount by controlling the motor of the motor drive unit 100 in the eighth step S380. Here, the control range of the stroke of the wheel 106 is set beforehand.

If the engine stops during the third step, the control flow ends.

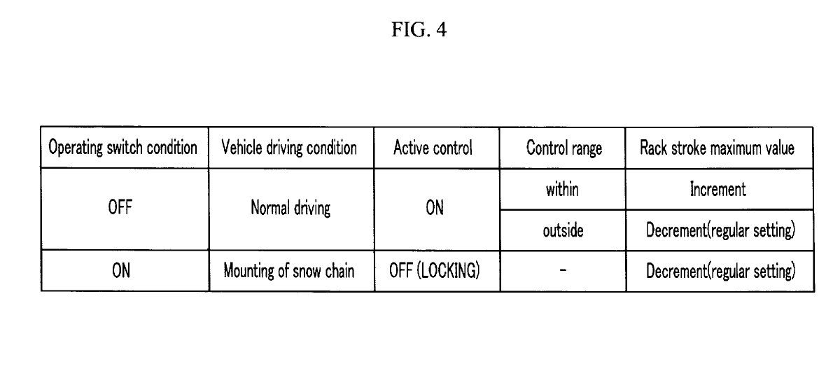

Referring to FIG. 4, in a case that the condition of the operating switch 110 is off, the stroke of the rack 120 is varied according to the stroke of the wheel 106, if the stroke of the wheel 106 is within a control range, the stroke of the rack 120 is increased to a predetermined value, and if the stroke of the wheel 106 is out of the control range, the stroke of the rack 120 is decreased to a predetermined value.

In a case that the condition of the operating switch 110 is on, the stroke of the rack 120 is decreased to a predetermined value regardless of the driving condition.

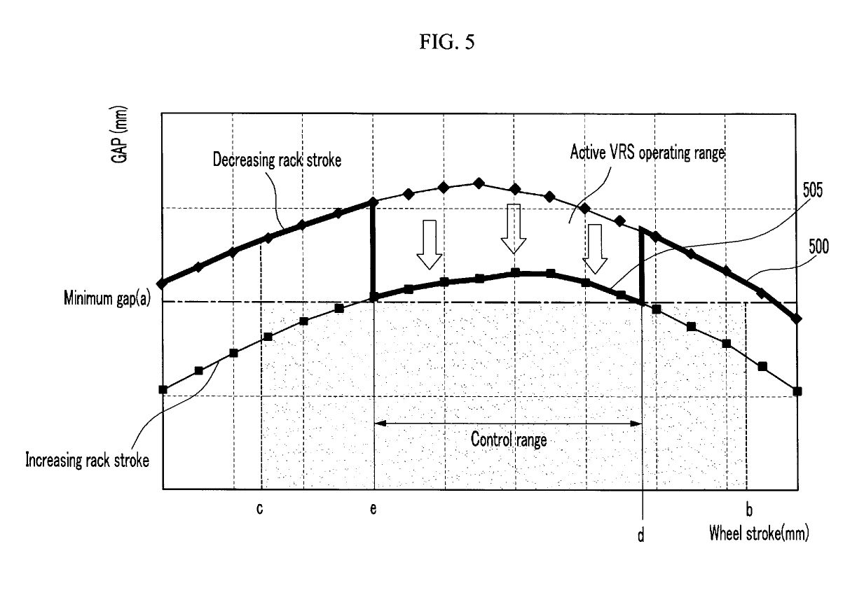

Referring to FIG. 5, the horizontal axis signifies the stroke of the wheel 106. That is, it shows the height of the wheel 106, in a case that it is a negative value, it is considered a rebound condition and the distance between the lower arm and the vehicle body is increased from a standard value, and in a case that it is a positive value, it is considered a bump condition and the distance between the lower arm and the vehicle body is decreased from a standard value.

Further, the vertical axis signifies a gap between the wheel 106 and a component of the vehicle body, and the minimum value thereof is set to a predetermined value.

The first line 500 shows a gap between the wheel 106 and the vehicle body 220 depending on the bump or the rebound condition of the vehicle body 220, in a case that the maximum stroke of the rack 120 is reduced.

In a case that the operating switch is off, the stroke of the wheel 106 is within a control range from e to d, and the maximum stroke of the rack 120 is increased from the first line 500 to the second line 505, while a decreased condition is sustained in the other range that is out of the control range.

In a condition that the operating switch 110 is on, the maximum stroke (movement limit) of the rack 120 sustains the decreased limit.

In various embodiments of the present invention, the control unit 140 can detect the rotation of the motor of the motor drive unit 100 to detect the stroke of the rack 120, and can also detect the stroke of the rack 120 from a sensor sensing the position of the rack 120.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A motor driven power steering device, comprising:
a motor drive unit equipped with a motor selectively moving a rack so as to change steering angle; and
a control unit configured for detecting a moving direction of a steering wheel, and operating the motor in accordance with the moving direction, and controlling the motor so as to vary the maximum stroke of the rack.

2. The motor driven power steering device of claim 1, wherein the control unit reduces the maximum stroke of the rack by a predetermined amount when an operating switch is on.

3. The motor driven power steering device of claim 1, wherein the control unit varies the maximum stroke of the rack to a predetermined value when an operating switch is off.

4. The motor driven power steering device of claim 3, wherein a vehicle height sensor unit includes:
a vehicle height sensor fixed on a vehicle body; and
a link having a lower end fixed to a lower arm and an upper end is connected to the vehicle height sensor,
wherein the vehicle height sensor detects movement of the link connected to the lower arm and calculates distance between the vehicle body and the lower arm, and the control unit calculates a wheel stroke amount based on the distance between the vehicle body and the lower arm.

5. The motor driven power steering device of claim 3, wherein the maximum stroke of the rack is increased when a wheel stroke is in a predetermined control range.

6. The motor driven power steering device of claim 3, wherein the maximum stroke of the rack is decreased when a wheel stroke is out of a predetermined control range.
